(19) United States
(12) Patent Application Publication
(10) Pub. No.: US 2003/0140164 A1
(43) Pub. Date: Jul. 24, 2003

(54) Duplexing method and repeating apparatus in transparent lan service and transparent lan service system

(76) Inventor: Takuya Kitamura, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/195,720

(22) Filed: Jul. 15, 2002

(30) Foreign Application Priority Data
Jan. 18, 2002 (JP) 2002-009987

(51) Int. Cl. G06F 15/173

(52) U.S. Cl. 709/238

(57) ABSTRACT

A system comprised of an active side network by which only a plurality of active side repeating apparatuses can provide a transparent LAN service to each other, a waiting side network by which only a plurality of waiting side repeating apparatuses can provide a transparent LAN service to each other, and active/waiting side switch units for switching the active side repeating apparatuses and waiting side repeating apparatuses between these two by communication using specific frames.

### BACKGROUND OF THE INVENTION

1. Field of the Invention

The present invention relates to a network constructed by a plurality of networks belonging to a first type as a private network on a network belonging to a second type and a repeating apparatus used for the same, more particularly relates to a transparent LAN service system for providing a transparent LAN service and a repeating apparatus used for the same.

2. Description of the Related Art

Networks which used to be realized by ISDN, dial-up using telephone lines, or leased lines/frame relay/ATMs are rapidly being replaced by inexpensive flat rate networks due to the appearance of ADSL/FTTH and other new high speed transmission technology and increased competition among carriers.

Layer 2 protocol, that is, the Ethernet, enabling the easy connection and inexpensive construction of networks, has come into use not only for general user-oriented services, but also business-oriented services. For example, a L2 (Layer 2)-VPN service has appeared. L2-VPN is a type of transparent LAN service. It uses the bridge function of an L2 switch to pass user Ethernet frames through the network as they are.

Transparent LAN services include services using an L2 switch such as the above L2-VPN and also services provided by installing MPLS, PPP, or other protocols for transmission through the Ethernet on networks of ATMs or leased lines.

The present invention concerns means for constructing a highly reliable network system by duplexing access channels using only Layer 2 functions when using a transparent LAN service provided by a carrier etc. and a service provided using that system.

In the past, the L2-VPN and other transparent LAN services provided by carriers etc. had a plurality of users connected to them, so prohibited communication between different users in order to maintain security among the users. For this purpose, the control technique known as a Virtual LAN (VLAN) defined by IEEE 802.1Q is employed. Note that VLAN functions are installed in almost all products supporting bridge functions.

Summarizing the problems to be solved by the invention, normally, in an L2-VPN or other transparent LAN service, there is a single access channel, and it is not possible to increase the reliability by duplexing the access channels as seen in other VPN services. The reason is that the rules of the Ethernet do not allow formation of loop configurations, however, the duplexing would end up creating a loop. As a means for solving this, the carriers etc. can run the spanning tree protocol (STP) defined by IEEE 802.1D for each LAN so as to prevent the formation of loops logically or can change the hardware installed by the service user side to routers of Layer 3 hardware.

At the present time, however, services running the STP for each VLAN are not being provided. Even if the user side sends STP protocol frames, they end up being ignored or discarded, so loops cannot be eliminated.

Therefore, in a conventional transparent LAN (L2-VPN) service, there was the problem that it was not possible to use Ethernet switches to form a redundant configuration (duplexing of channels for backup route).

Despite the fact that future networks will be required to be increasingly reliable, this problem causes the situation that access channels cannot be duplexed using inexpensive L2 switches in inexpensive L2-VPNs and therefore poses an obstacle in the growth of the Internet community.

### SUMMARY OF THE INVENTION

An object of the present invention is to provide a duplexing method, repeating apparatus, and system able to realize duplexing of access channels in a transparent LAN service simply and inexpensively without changing the hardware at the service provider side.

To attain the above object, the present invention provides a system (10) comprised of an active side network (12) by which only a plurality of active side repeating apparatuses (15) can provide a transparent LAN service, a waiting side network (13) by which only a plurality of waiting side repeating apparatuses (15) can provide a transparent LAN service, and active/waiting side switch means (14) for switching the active side repeating apparatuses (15) and waiting side repeating apparatuses (15) between these two by communication using specific frames.

### BRIEF DESCRIPTION OF THE DRAWINGS

These and other objects and features of the present invention will become clearer from the following description of the preferred embodiments given with reference to the attached drawings, wherein:

FIG. 1 is a conceptual view of a transparent LAN service system according to the present invention;

FIG. 2 is a functional block diagram of the basic configuration of a repeating apparatus 15 according to the present invention;

FIG. 3 is a view of an example of the configuration of a transparent LAN service system to which the present invention is applied;

FIG. 4 is a view of the general block configuration of the repeating apparatus 15 shown in FIG. 3;

FIG. 5 is a view of the overall layout of FIGS. 5A and 5B;

FIGS. 5A and 5B are a first part of a flow chart for explaining the operation of the repeating apparatus initially set as the active side;

FIG. 6 is a second part of a flow chart for explaining the operation of the repeating apparatus initially set as the active side;

FIG. 7 is a third part of a flow chart for explaining the operation of the repeating apparatus initially set as the active side;

FIG. 8 is a fourth part of a flow chart for explaining the operation of the repeating apparatus initially set as the active side;

FIG. 9 is a fifth part of a flow chart for explaining the operation of the repeating apparatus initially set as the active side;

FIG. 10 is a view of the overall layout of FIGS. 10A and 10B;

FIGS. 10A and 10B are a first part of a flow chart for explaining the operation of the repeating apparatus initially set as the waiting side;

FIG. 11 is a second part of a flow chart for explaining the operation of the repeating apparatus initially set as the waiting side;

FIG. 12 is a third part of a flow chart for explaining the operation of the repeating apparatus initially set as the waiting side;

FIG. 13 is a fourth part of a flow chart for explaining the operation of the repeating apparatus initially set as the waiting side;

FIG. 14 is a fifth part of a flow chart for explaining the operation of the repeating apparatus initially set as the active side;

FIG. 15 is a view of an example of a survival confirmation table T;

FIG. 16 is a view of the data formats of a “survival confirmation frame”, “switch frame”, and “switchback frame”;

FIG. 17 is a view of a first embodiment of the repeating apparatus 15;

FIG. 18 is a view of a second embodiment of the repeating apparatus 15; and

FIG. 19 is a view of a third embodiment of the repeating apparatus 15.

### DESCRIPTION OF THE PREFERRED EMBODIMENTS

Preferred embodiments of the present invention will be described in detail below while referring to the attached figures.

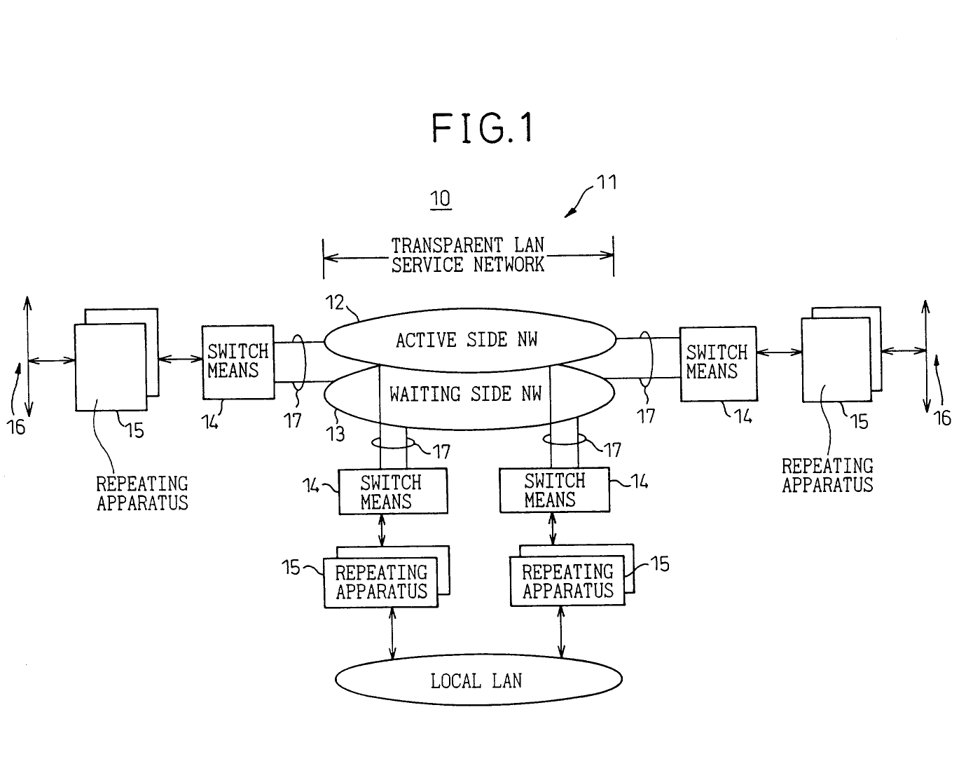

FIG. 1 is a conceptual view of a transparent LAN service system according to the present invention.

In the figure, reference numeral 10 shows a transparent LAN service system as a whole.

The system 10 has, as inherent components, a network belonging to a second type, for example, a transparent LAN service network 11, and a plurality of user side repeating apparatuses 15 communicating with each other through that service network 11. Note that the repeating apparatuses 15 are generally connected with networks belonging to a first type, for example, user side local LANs 16.

In the figure, the components to be particularly noted are the logically mutually independent active side network (NW) 12 and waiting side network (NW) 13 and active/waiting side switch means 14. The active side network (NW) 12 and waiting side network (NW) 13 may also be logically mutually independent private networks constructed by the transparent LAN service network 11.

More specifically, the transparent LAN service system 10 according to the present invention is comprised of (i) an active side network 12 by which only a plurality of active side repeating apparatuses 15 can provide transparent LAN services to each other, (ii) a waiting side network 13 by which only a plurality of waiting side repeating apparatuses 15 can provide transparent LAN services to each other, and (iii) active/waiting side switch means 14 for switching the repeating apparatuses 15 of the active side network 12 side and repeating apparatuses 15 of the waiting side network 13 side between these two by communication using specific frames (for example, Ethernet frames) mutually interpretable among these repeating apparatuses 15 and thereby duplexing the access channels.

The active/waiting side switch means 14, as explained later, can be configured simply and inexpensively and configured integrally with the repeating apparatuses 15 by just some modification to the same, so duplexing of the access channels (FIG. 1) in a transparent LAN service is realized simply and inexpensively.

Next, before going into detailed embodiments, the transparent LAN service system according to the present invention as a whole will be summarized.

<1> Two networks (12 and 13), that is, the normally used “active side” network and the “waiting side” network used only when the active side network cannot be used, are constructed in the transparent LAN service.

In actuality, in the transparent LAN service network 11, the active side and the waiting side contract with the service provider side as different users so that they are unable to communicate with each other. The service provider side cannot distinguish between the “active” and “waiting” sides. It only sees that two users have contracted separately. Further, it is possible for users to contract with two service providers for different transparent LAN services.

<2> The active side repeating apparatuses 15 and waiting side repeating apparatuses 15 connected to the active side and waiting side networks (12 and 13) transmit survival confirmation signals (frames) to indicate to the other side that they are normally operating once every few or every tens of seconds.

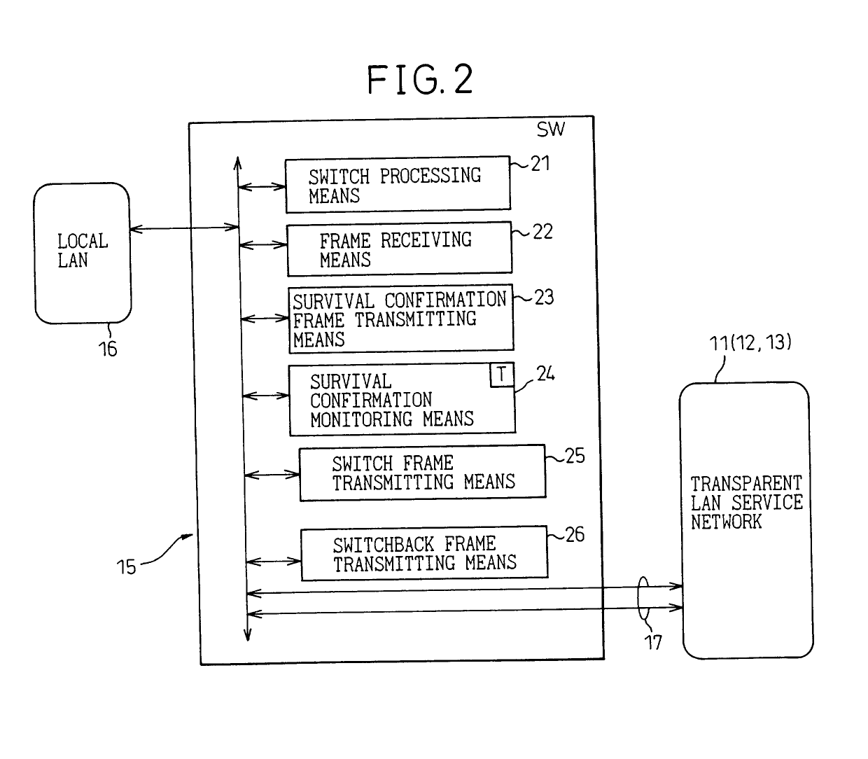

Note that the term “repeating apparatus (15)” represents all of L2 switches, L3 switches, bridges, routers, repeaters, media converters, etc. Below, however, for simplification, the repeating apparatus (15) will sometimes be abbreviated as “SW” (switch).

<3> Each SW prepares a survival confirmation table (T in FIG. 2) based on the survival confirmation signals sent by other SWs and received from the transparent LAN service network 11 side.

The survival confirmation table has SW identifiers and corresponding life timers. These life timers show the period during which the corresponding SW entries are valid.

<4> When there is no abnormality in the network, an active side SW performs the inherent switch processing (bridge function) of a conventional SW and relays the Ethernet frames.

On the other hand, a waiting side SW discards general frames other than the specific frames used for updating the survival confirmation table.

<5> If an opposing SW from which a survival confirmation signal has not been transmitted for a certain time is found using the survival confirmation table among the opposing SWs entered in the table, it is judged that an abnormality has occurred in the network and this fact is notified to the waiting side SW of its own pair, that is, the SW paired with that active side SW at the same location. Next, the active side and waiting side are switched.

The previous active side SW now the waiting side continues to update its survival confirmation table even after the communication route (access channel) is switched to the waiting side. Relaying of other signals, however, is stopped.

When the above abnormality has been restored and the active side network returns to normal, that fact is notified to the waiting side SW and relaying of signals in the active side network can be resumed. Instead of this resumption, however, it is also possible to maintain the present status and merely inform the face of the return to normalcy to the system manager.

<6> The waiting side SW receiving the message of the occurrence of a network abnormality in the first half of the above <5> operates as the active side and starts relaying the inherent signal repeating.

Thereafter, the waiting side SW becoming the active side prepares and updates a survival confirmation table in the same way as the active side SW of the above <4>.

Next, when there is an abnormality in the waiting side network, this fact is notified (alarm) to the system manager.

The above explained transparent LAN service system according to the present invention is also a novel duplexing method in a transparent LAN service. This duplexing method is for duplexing the access channels for providing a transparent LAN service and

(i) realizes a transparent LAN service by an active side network 12 where only the plurality of active side repeating apparatuses (SW) can communicate with each other and a waiting side network 13 where only the plurality of waiting side repeating apparatuses (SW) can communicate with each other and

(ii) switches the repeating apparatuses (SW) at the active side network 12 and the repeating apparatuses (SW) at the waiting side network 13 between these two by communication using specific frames mutually interpretable by only the repeating apparatuses (SW).

In this duplexing method, the above-mentioned transparent LAN service is for example an L2-VPN, while the above specific frames are for example specific Ethernet frames.

The transparent LAN service system 10 and above duplexing method of the present invention explained above are specifically realized by the active/waiting side switch means 14 shown in FIG. 1. Note that the switch means 14 may be built into the above SWs, that is, repeating apparatuses 15, or may be added to the apparatuses 15, but in the following embodiments, the explanation will be made based on the former case, that is, the case where the switch means 14 are built integrally into the repeating apparatuses 15.

FIG. 2 is a functional block diagram of the basic configuration of the repeating apparatus 15 according to the present invention.

The repeating apparatus 15 shown in the figure, as illustrated, includes a switch processing means 21, a frame receiving means 22, a survival confirmation frame transmitting means 23, a survival confirmation monitoring means 24, a switch frame transmitting means 25, and a switchback frame transmitting means 26. It is however not necessarily essential to provide all of these means 21 to 26 simultaneously.

That is, the repeating apparatus 15 according to the embodiments of the present invention is a repeating apparatus arranged between the transparent LAN service network 11 and a local LAN 16 for providing the transparent LAN service and is provided with at least the above means 21, 22, 23, and 24.

The switch processing means 21 switches general frames for data communication transferred between the transparent LAN service network 11 and the local LAN 16.

The survival confirmation frame transmitting means 23 transmits a survival confirmation frame indicating that the repeating apparatus 15 is surviving from that repeating apparatus to the other opposing repeating apparatuses by a predetermined period.

The frame receiving means 22 receives opposing side survival confirmation frames similar to the above survival confirmation frame and the above general frames transmitted from the opposing repeating apparatuses and transfers any general frames received to the switch processing means 21.

When the switch processing means 21 receives the above opposing side survival confirmation frame, the survival confirmation monitoring means 24 holds that opposing side survival confirmation frame corresponding to the opposing side repeating apparatus. When receiving the next opposing side survival confirmation frame, it holds a flag indicating that the opposing repeating apparatus is surviving until the elapse of a predetermined holding period, for example, in the survival confirmation table T, while when that holding period elapses without the next opposing side survival confirmation frame being received, erases that flag.

Further, when the above flag has been erased by the survival confirmation monitoring means 24, the repeating apparatus 15 operating as the active side is switched to the waiting side repeating apparatus and, simultaneously, the repeating apparatus 15 operating as the waiting side is switched to the active side repeating apparatus.

The repeating apparatus 15 is preferably further provided with a switch frame transmitting means 25.

The switch frame transmitting means 25 transmits a switch frame by which the active side repeating apparatus 15 instructs the waiting side repeating apparatus 15 paired with it to switch to the active side when the above flag is erased by the survival confirmation monitoring means 24.

More preferably, the repeating apparatus 15 is further provided with a switchback frame transmitting means 26. This means 26 transmits a switchback frame by which the active side repeating apparatus 15 instructs the waiting side repeating apparatus paired with that active side repeating apparatus to switch back to its inherent waiting side when the above flag is erased by the survival confirmation monitoring means 24 in the state where the active side repeating apparatus 15 has once been switched to the waiting side. Further, the active side repeating apparatus is switched back to its inherent active side.

Conversely from the above, the waiting side repeating apparatus is switched back to its inherent waiting side when the frame receiving means 22 receives said switchback frame from the active side repeating apparatus paired with that waiting side repeating apparatus without receiving the above survival confirmation frame in the state where the waiting side repeating apparatus has once been switched to the active side.

Further explaining the frame receiving means 22, the means 22 discards general frames when receiving general frames in the state where the active side repeating apparatus has been switched once to the waiting side.

Further, the frame receiving means 22 of the waiting side repeating apparatus discards any general frames received at all times.

Still further, the waiting side repeating apparatus generates an alarm for notifying the fact of an abnormality in the transparent LAN service when the above flag has been erased by the survival confirmation monitoring means 24.

The above embodiment of the present invention will be explained more specifically and in further detail below.

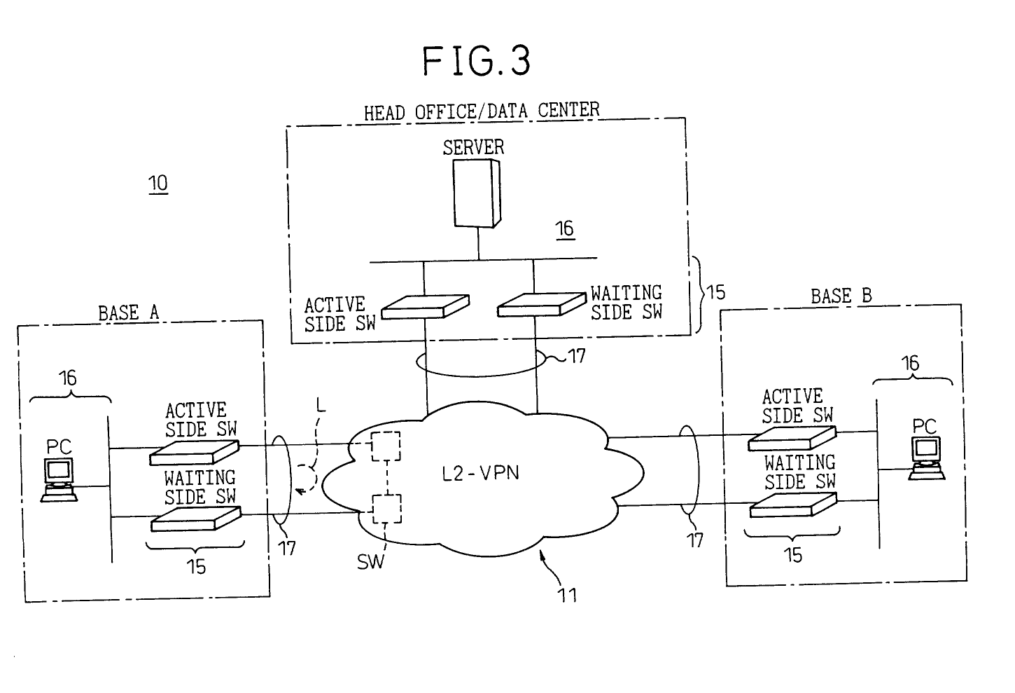

FIG. 3 is a view of an example of the configuration of a transparent LAN service system to which the present invention is applied. Note that throughout the figures, the similar components are assigned the same reference numerals or symbols.

In an L2-VPN, in the past it was not possible to construct the duplexed configuration of the access channels 17 as shown in FIG. 3. The reason is that a loop L as shown by the dotted line in FIG. 3 would end up being formed. Note that the dotted line SW shows the repeating apparatus in the L2-VPN 11.

As opposed to this, the present invention comes up with the idea of preventing the formation of a loop L even if duplexing the access channels 17 as shown in FIG. 3.

Referring to FIG. 3, the system 10 of the present invention is comprised of two bases A and B and one head office or data center connected by two access channels 17 each to a transparent LAN service network 11, here, an L2-VPN, provided by a carrier etc. The two SWs (repeating apparatuses 15) at the bases and the data center are initially set to active and waiting sides. In the present invention, the access channels 17 to the L2-VPN 11 connected to the apparatuses 15 are considered to belong to separate users, where contracts are required with the service provider. That is, in the L2-VPN 11, the network 12 to which only the active side SWs are connected and the network 13 to which only the waiting side SWs are connected logically independently exist. An active side SW and a waiting side SW cannot communicate with each other through the L2-VPN 11. Due to this, the formation of the above-mentioned loop L is prevented.

However, the pair of the active side SW and waiting side SWs at each base or the data center can communicate with each other through the local LAN 16.

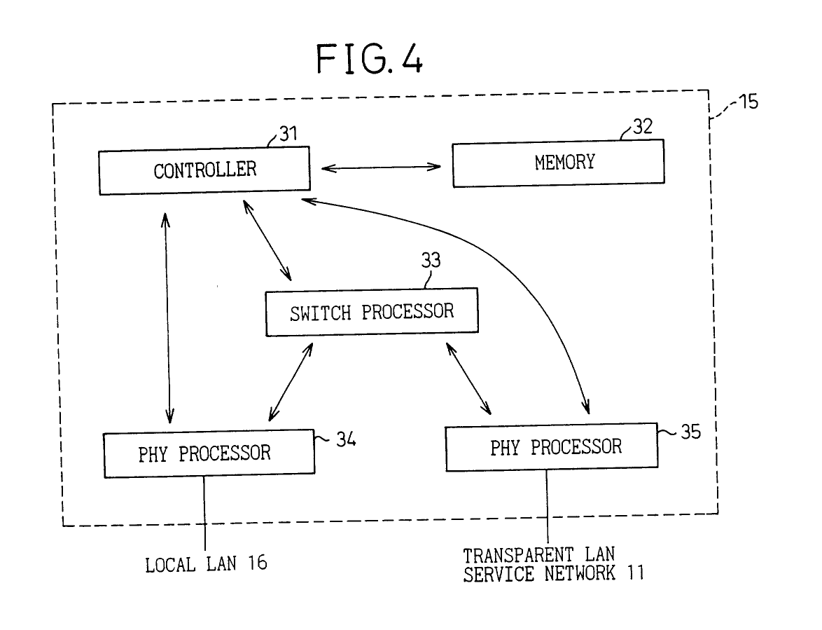

FIG. 4 is a view of the schematic block configuration of the repeating apparatus 15 shown in FIG. 3.

The active side SW and the waiting side SW have similar configurations to this figure.

In the figure, the repeating apparatus 15 has a switch processor 33 as its main component. This switch processing includes repeat processing when the apparatus 15 is the above-mentioned repeater.

The switch processor 33 is initialized by a controller 31 in accordance with a program stored in a memory 32. The controller 31 generates the various types of frames mentioned above and instructs the switch processor 33 to transmit the generated frames. Based on this instruction, the above generated frames are transmitted to the outside through physical layer (PHY) processors 34 and 35.

Further, the controller 31 counts the above-mentioned “holding period” or “predetermined period” and monitors the above-mentioned survival confirmation table T loaded in part of the memory 32 during that “holding period”.

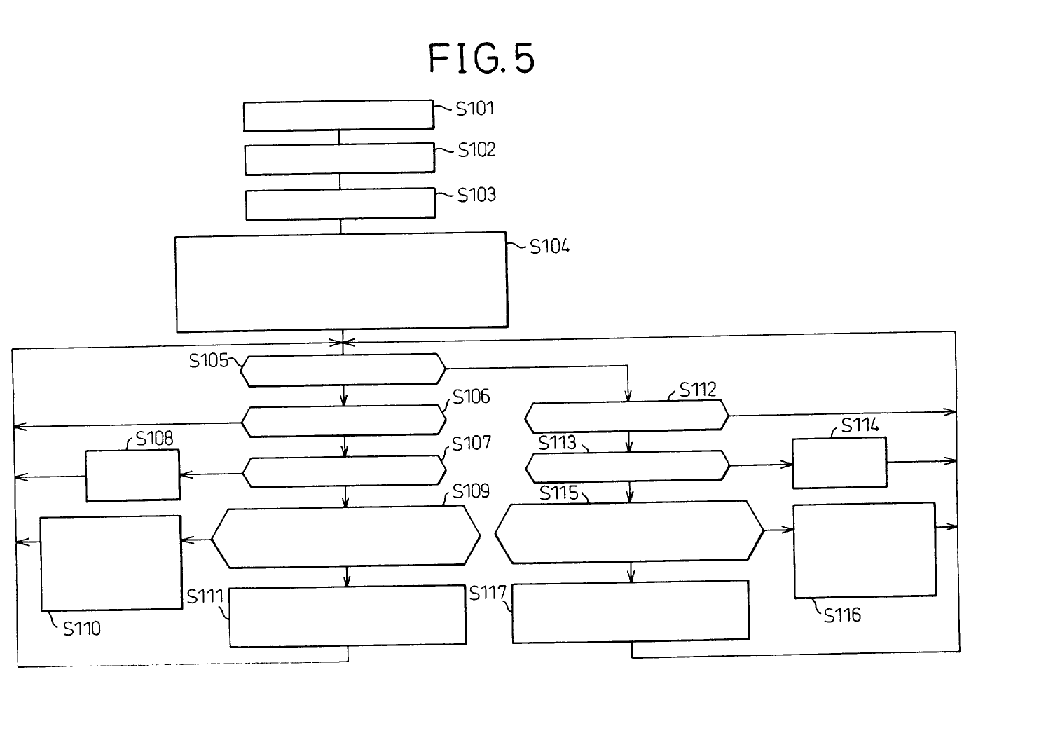

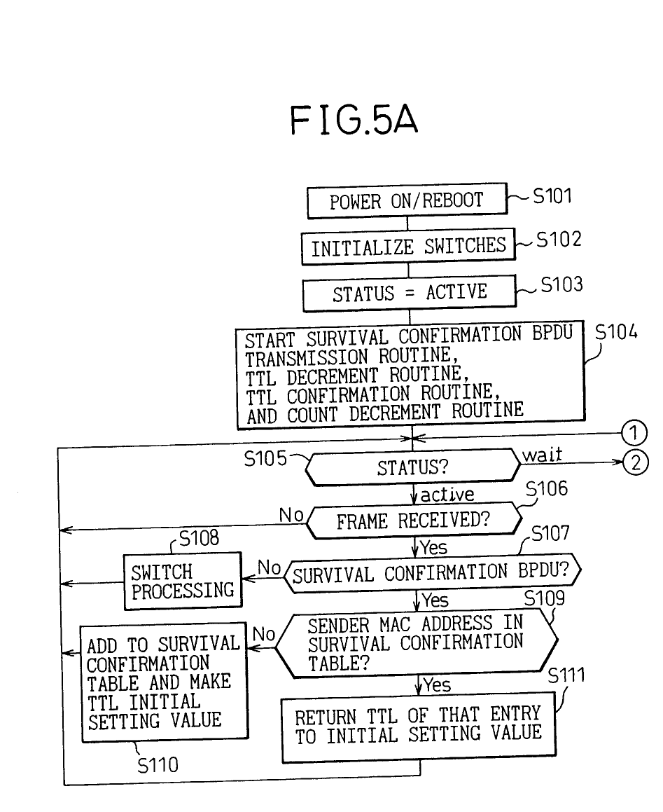

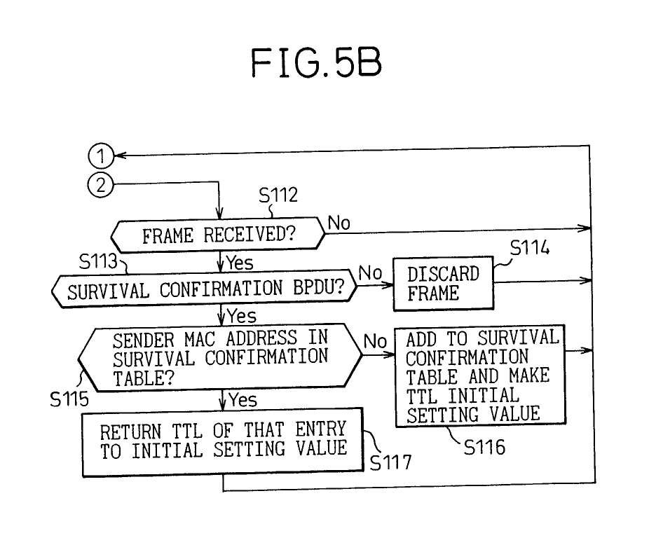

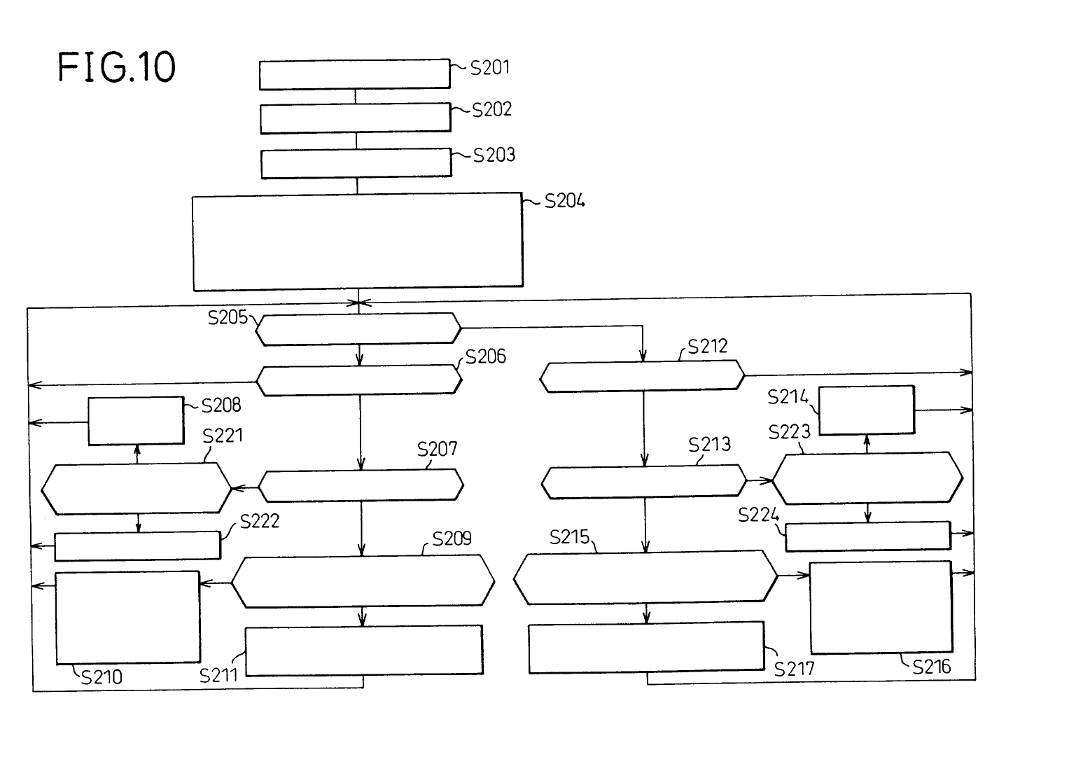

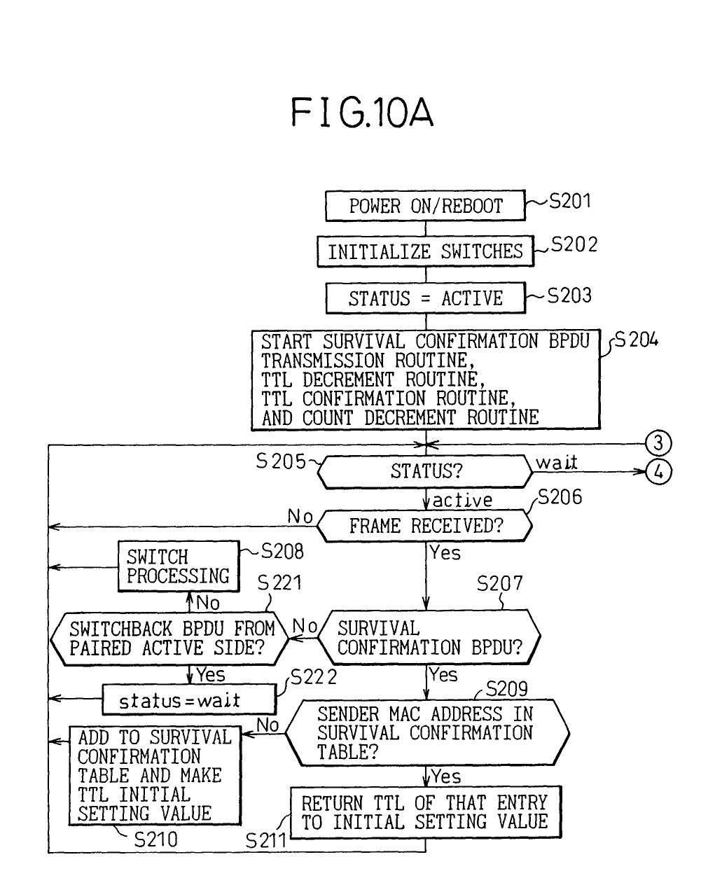

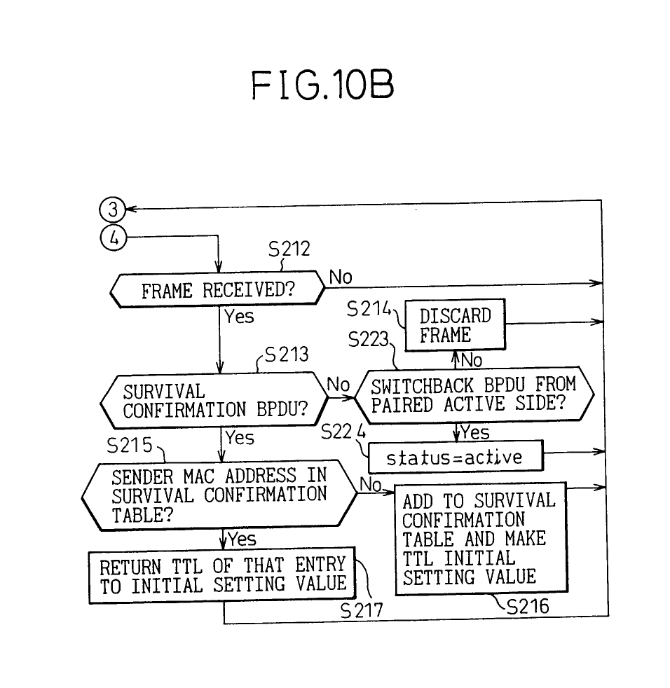

Details of the operation of the repeating apparatus 15 of FIG. 4 will be explained with reference to FIG. 3, FIG. 5 to FIG. 9, and FIG. 10 to FIG. 14 etc.

FIG. 5 to FIG. 9 are first to fifth parts of a flow chart explaining the operation of a repeating apparatus initially set as the active side.

On the other hand, FIG. 10 to FIG. 14 are first to fifth parts of a flow chart explaining the operation of a repeating apparatus initially set as the waiting side.

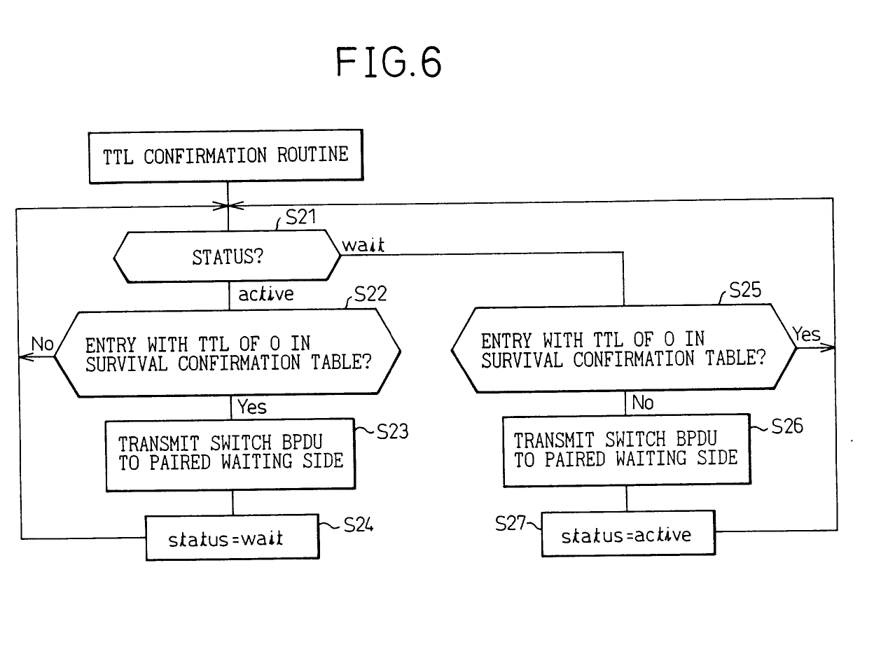

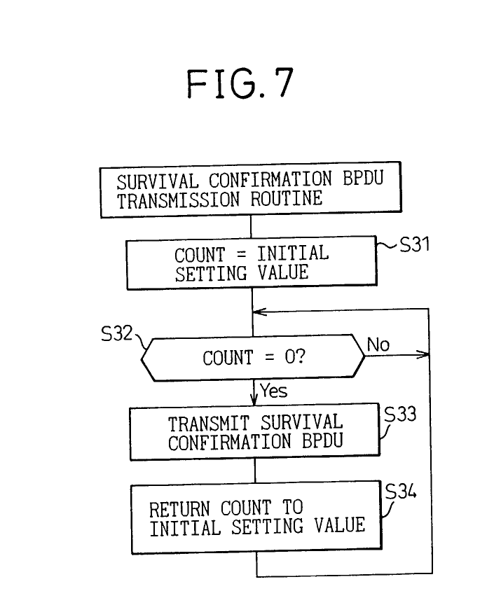

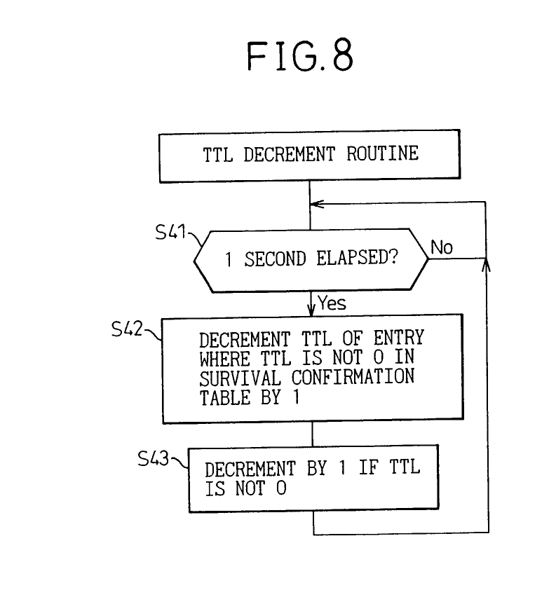

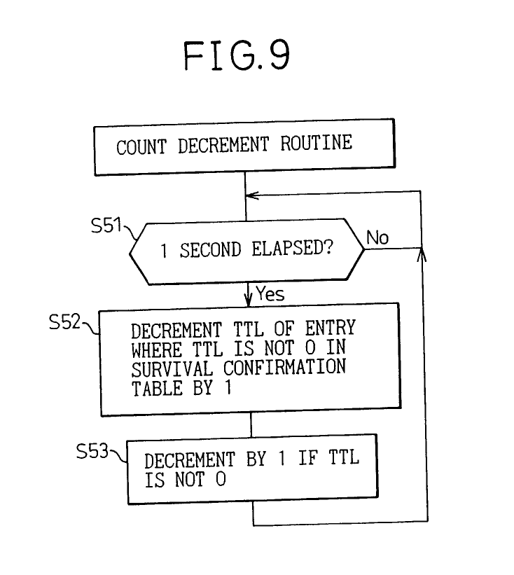

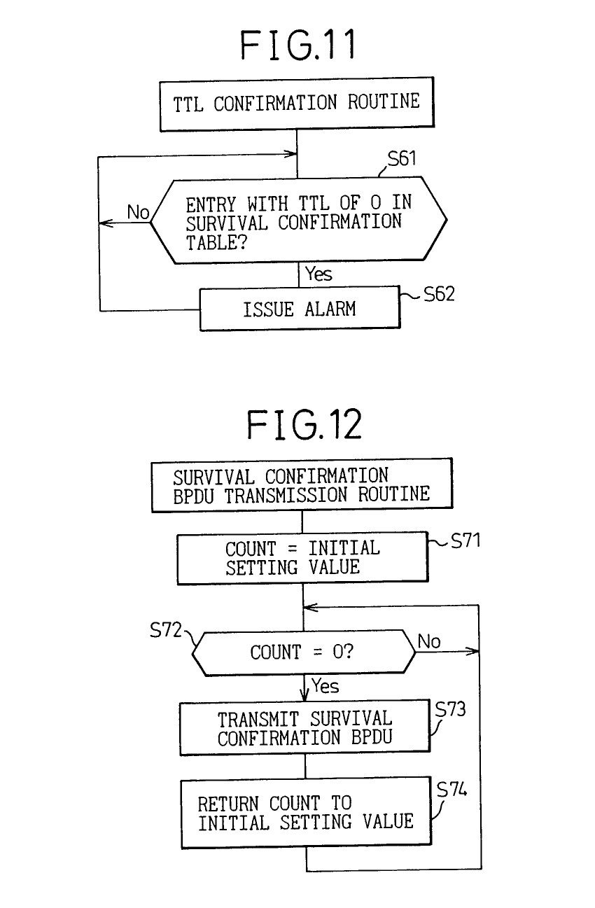

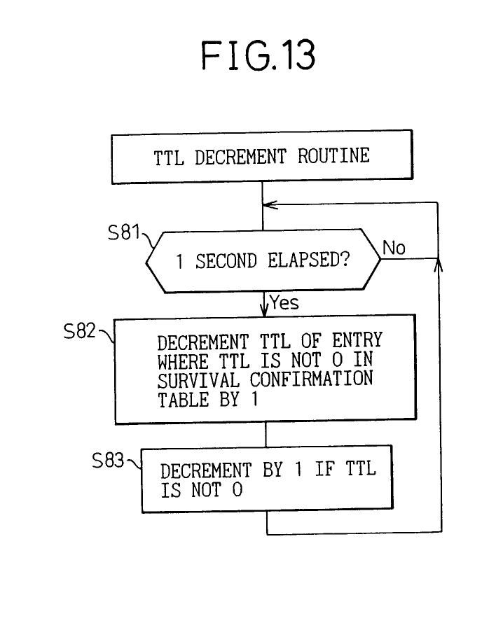

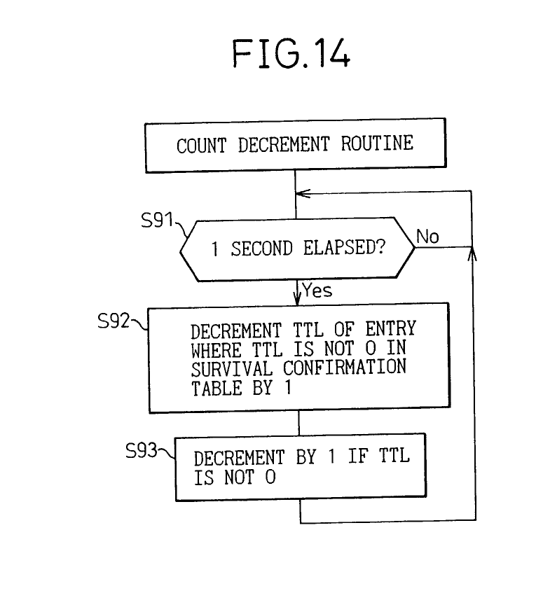

In particular, FIG. 6 and FIG. 11 show a “TTL (Time to Live) confirmation routine”, FIG. 7 and FIG. 12 show a “survival confirmation BPDU transmission routine”, FIG. 8 and FIG. 13 show a “TTL decrement routine”, and FIG. 9 and FIG. 14 show a “count decrement routine”.

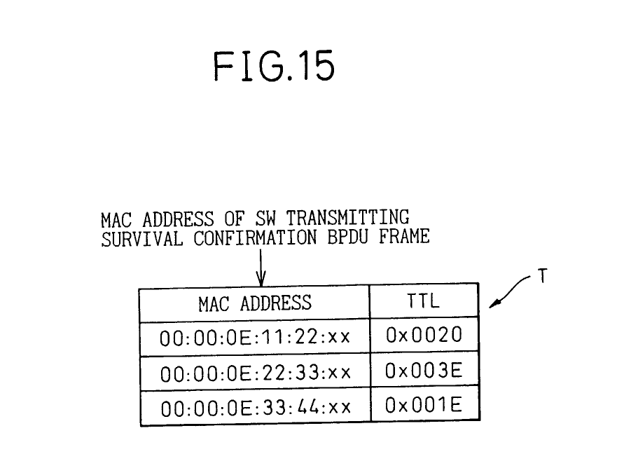

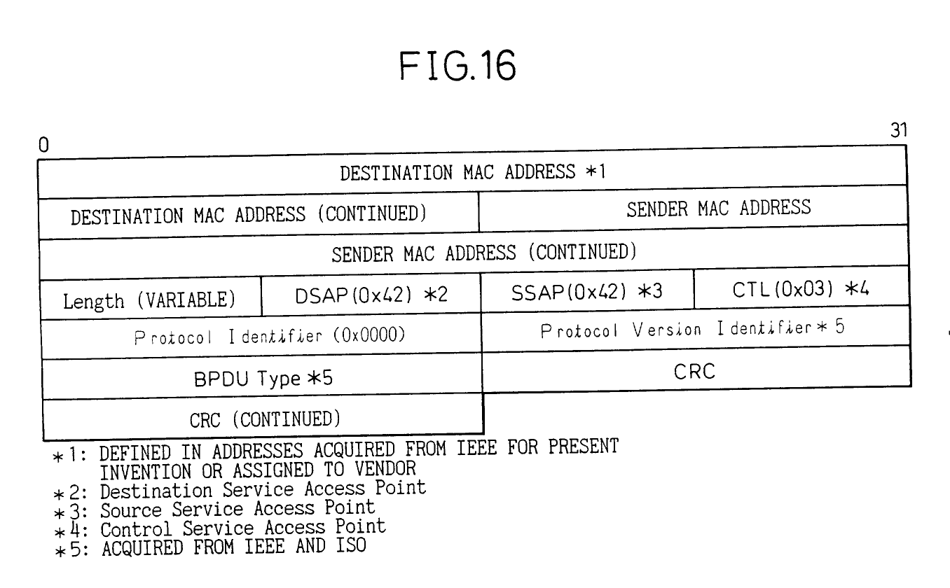

Here, “TTL”, means “Time To Live” and corresponds to the above-mentioned “holding period”. Further, “BPDU” means “Bridge Protocol Data Unit” and corresponds to the above-mentioned “survival confirmation frame”. Note that the TTL will be shown more specifically in FIG. 15, while the BPDU will be shown more specifically in FIG. 16.

FIG. 15 is a view of an example of a survival confirmation table T, while FIG. 16 is a view of the data formats of the “survival confirmation frame”, “switch frame” and “switchback frame”.

Here, returning to FIGS. 5, 5A and 5B, an explanation will be given of the operation of the active side SW at each base or the data center when constructing a network and first turning on the power (or when rebooting) (step S101). The controller 31 (FIG. 4) initializes the switch processor 33 by a program stored in the memory 32 (step S102). Since it is set as the active side, the status initially becomes a value indicating “active” (step S103).

On the other hand, the “survival confirmation BPDU transmission routine” (FIG. 7), “TTL decrement routine” (FIG. 8), “TTL confirmation routine” (FIG. 6), and “count decrement routine” (FIG. 9) are also simultaneously started (step S104).

The “survival confirmation BPDU transmission routine” (FIG. 7) transmits a survival confirmation BPDU frame every certain set time (above-mentioned “predetermined period”) (steps S31 to S34). Note that the count decrement operation in this routine shows the count decrement routine of FIG. 9.

When transmitting the frame, the controller 31 (FIG. 4) generates the frame, instructs its transmission to the switch processor 33, and has the frame transmitted to the outside through the PHY processors 34 and 35.

Note that at this time, if recognizing the port connected to the transparent LAN service network 11 side and transmitting this frame to only that port, it is possible to suppress an increase in unnecessary traffic.

Further, the destination MAC address (FIG. 16) is relayed in the transparent LAN service network 11, while is to be defined in the addresses acquired from the IEEE or addresses assigned to vendors so that only hardware understanding the functions of the present invention can interpret it.

Here, the above survival confirmation BPDU frame is shown more specifically in FIG. 16. FIG. 16 shows the data formats of the survival BPDU frame (“survival confirmation frame”), switch BPDU frame (“switch frame”), and switchback BPDU frame (“switchback frame”).

Each data format, as illustrated, is comprised of the fields of the Destination MAC (Media Access Control) Address, Sender MAC Address, Length, DSAP, SSAP, CTL, Protocol Identifier, Protocol Version Identifier, BPDU Type, and CRC.

This configuration is the same for the survival confirmation frame, switch frame, and switchback frame, so it is necessary to use some means or another to identify these three types of frames.

For identification, specific values of the Protocol Identifier and BPDU Type are assigned to these three types of frames.

In the “TTL decrement routine” of FIG. 8, the controller 31 (FIG. 4) decrements the value of the TTL field in the survival confirmation table T loaded in the memory 32 by one each for example second (steps S41 to S43).

One example of the survival confirmation table T is shown in FIG. 15. The value of the TTL field is shown as “0×0020” etc. When the value of the TTL field becomes 0, it shows that the above-mentioned “holding period” has elapsed and it is learned that an abnormality has occurred (no survival confirmation frame has arrived) in the repeating apparatus 15 of the sender MAC address.

In the “TTL confirmation routine” of FIG. 6, the controller 31 (FIG. 4) constantly monitors if there is an entry with a TTL value of 0 in the survival confirmation table T in the memory 32.

The TTL value becoming 0 (YES at step S22) means that no survival confirmation BPDU frame has been received from the opposing SW even after waiting it for the initially set time (above-mentioned holding period). Therefore, the communication path (2, 2′) is considered to have been broken.

Therefore, to switch to the waiting side network, the switch BPDU frame of FIG. 16 is transmitted to the MAC address destination of the waiting side SW of the pair in the same base or the data center set in advance (step S23). Further, the active side SW itself makes the status a value showing “wait” so as to switch to the wait mode (step S24).

Here, explaining the inherent control shown in FIG. 5, the current status is “active” (step S105) and the SW waits to receive a frame. When receiving a frame from the local LAN 16 side, it switches the frame by the same operation as a conventional SW. That is, the controller stores the data recognized as a frame by the PHY processor (34 in FIG. 4) in the memory, confirms that it is a general frame for inherent operation, then passes that data to the switch processor 33 (step S108), and transmits it from the PHY processor 35. Conversely, it performs similar processing on a frame received from the transparent LAN service network 11 side.

Here, when receiving a survival confirmation BPDU frame transmitted by the survival confirmation BPDU transmission routine of FIG. 7 from the transparent LAN service network 11 side, that is, from an active side SW of a network separate from the network comprised by the active side SWs, the controller (31 in FIG. 4) refers to the survival confirmation table T (FIG. 15) in the memory 32. It confirms if the sender MAC address in the received survival confirmation BPDU frame is in the survival confirmation table T (step S109). If not, it newly adds an entry to the table T (step S110). The TTL value at that time is made the preset initial setting. If that MAC address is in the table T, it returns the TTL of the entry in the table to the initial setting (step S111).

Next, when communication has become no longer possible due to some reason or another, the status is switched to “wait” by the TTL confirmation routine (“wait” of step S105). When the status indicates the waiting side, even if general frames other than survival confirmation BPDU frames are received, these general frames are all discarded so as to prevent the formation of the above-mentioned loop L (steps S112, S113, and S114).

Further, the survival confirmation table T is updated by the reception of the survival confirmation BPDU frames in the same way as with the above active mode (steps S115, S116, and S117).

Further, in the TTL confirmation routine (FIG. 6), it is monitored whether the TTL value of any entry where the TTL value has become 0 in the survival confirmation table T is no longer 0. When no longer 0, that is, when the network has returned to normal, the active side SW transmits a switchback BPDU frame of FIG. 16 to instruct the waiting side SW paired with it in the same base or the data center to switch back (step S26).

Note that steps S201 to S217 in FIGS. 10A and 10B are the same as steps S101 to S117 in FIGS. 5A and 5B. In FIGS. 10A and 10B, however, steps S221 to S224 are newly added. Further, steps S71 to S74 of FIG. 12 are the same as steps S31 to S34 of FIG. 7, steps S81 to S83 of FIG. 13 are the same as steps S41 to S43 of FIG. 8, and steps S91 to S94 of FIG. 14 are the same as steps S51 to S54 of FIG. 9. On the other hand, the TTL confirmation routine of FIG. 11 differs from the corresponding routine of FIG. 6.

Next, the operation of a waiting side SW will be explained with reference to FIG. 10 to FIG. 14. The basic operation of the waiting side SW (survival confirmation BPDU transmission routine, TTL decrement routine, etc.) is the same as the case of the active side SW (FIG. 5 to FIG. 9). The difference from the active side SW is that the status is updated not by judgement of the waiting side SW itself, but based on an instruction from the active side SW.

After it is confirmed that a received frame is not a survival confirmation BPDU frame (NO at step S213 of FIG. 10B), it is confirmed if the frame is a switch BPDU frame from the MAC address of an active side SW paired with it in the same base or the data center (step S223 of FIG. 10B). If not a switch BPDU frame, that frame (the above-mentioned general frame) is discarded so as to avoid the formation of a loop L (step S214 of FIG. 10B).

If corresponding to the MAC address of the paired active side SW, the status is immediately changed to a value indicating “active” (step S224 of FIG. 10B).

The waiting side SW in the active mode (YES at step S205 of FIG. 10A) normally switches frames other than the survival confirmation BPDU frames and switchback BPDU frame from the paired active side SW, that is, general frames (steps S221 and S208 of FIG. 10A).

On the other hand, when receiving a switchback BPDU frame, the status is immediately changed to a value indicating “wait” (steps S221 and S222 of FIG. 10A).

The operation of the “TTL confirmation routine” of FIG. 11 also differs from that routine of the active side SW (FIG. 6). When it is judged that the path of the waiting side network 13 has become impassable (abnormal) due to some reason or another by the updating/monitoring of the survival confirmation table T by the TTL confirmation routine of the waiting side (YES at step S61 of FIG. 11), an alarm is raised to notify this impassable state to the system manager regardless of whether the waiting side SW is in the active mode or wait mode (step S62 of FIG. 11). Depending on the operation of the system, however, normal communication processing may be continued with part still in the faulty state.

Finally, embodiments of the repeating apparatus 15 will be explained.

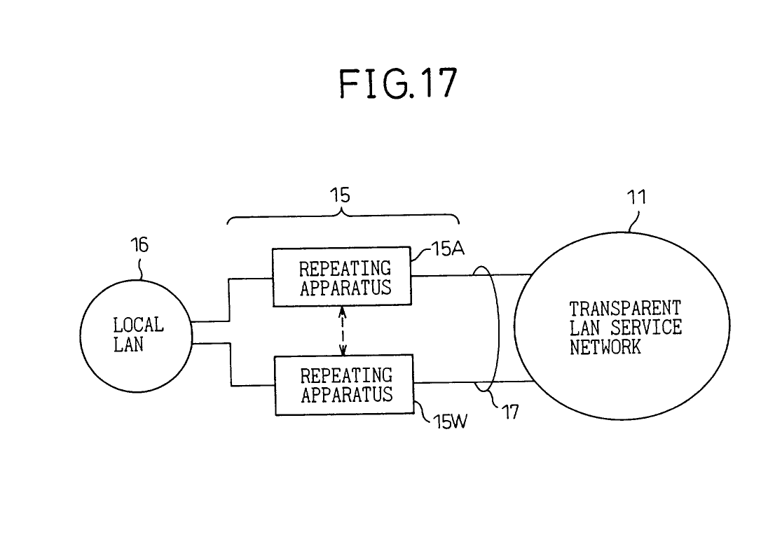

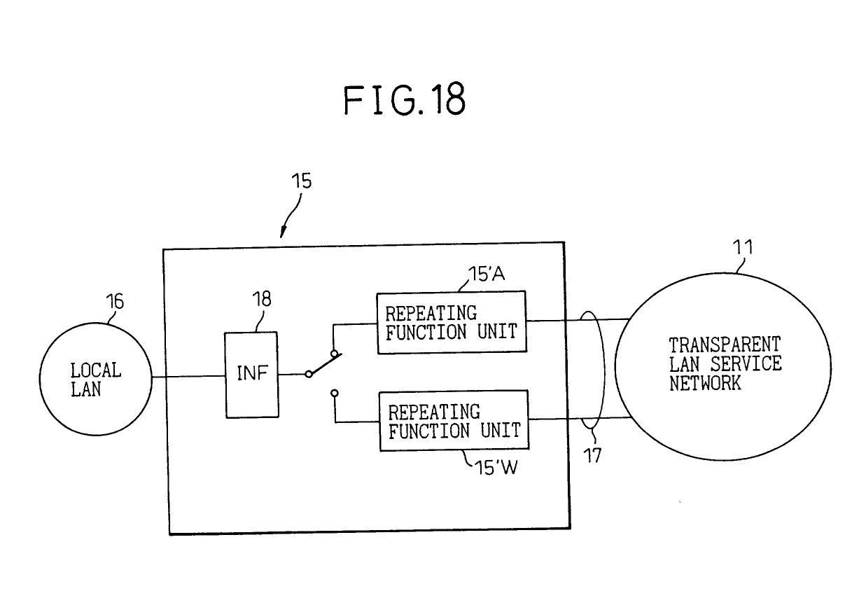

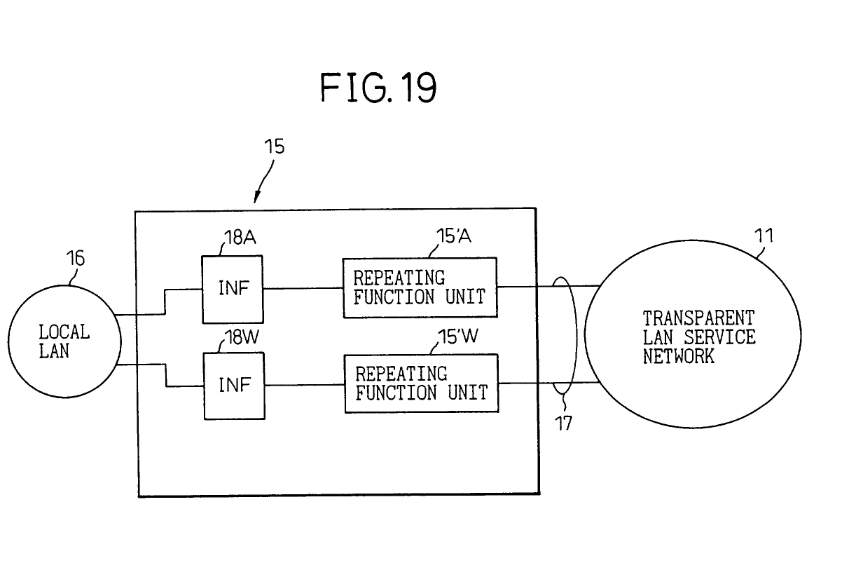

FIG. 17 is a view of a first embodiment of the repeating apparatus 15, FIG. 18 is a view of a second embodiment of the repeating apparatus 15, and FIG. 19 is a view of a third embodiment of the repeating apparatus 15.

First, referring to FIG. 17, this embodiment is characterized by providing the active side repeating apparatus 15A and waiting side repeating apparatus 15W independently and linking the two, that is, operating the two complementarily.

Next, referring to FIG. 18, this embodiment is characterized by mounting an active side repeating function unit 15′A and waiting side repeating function unit 15′W to be mounted in an active side repeating apparatus and a waiting side repeating apparatus and a single interface 18 for commonly connecting these repeating function units and external networks (11, 16) in a single apparatus 15 and selectively switching to one of the active side repeating function unit 15′A and waiting side repeating function unit 15′W by specific settings.

Further, referring to FIG. 19, this embodiment is characterized by providing an active side repeating function unit 15′A and waiting side repeating function unit 15′W to be mounted in an active side repeating apparatus and a waiting side repeating apparatus, respectively, and two interfaces 18A and 18W for separately connecting these repeating function units and external networks (11, 16) in a single apparatus 15 and simultaneously operating these repeating function units.

As shown in FIG. 18 and FIG. 19, by mounting the active side SW functions (15′A) and waiting side SW functions (15′W) in a single apparatus 15 and enabling these to be switched between by specific settings, it becomes possible to flexibly cope with demands from the users such as the following (a) and (b):

(a) It is possible to first construct a system by a single access channel (17) and expand this to a duplex configuration in accordance with need in the future.

(b) It is possible to replace just the active side SWs with new hardware and use the active side SWs used up to then as the waiting side SWs for duplexing.

Further, as shown in FIG. 19, by providing two interfaces (18A and 18W and simultaneously operating the functions of the active side SW (15′A) and the functions of the waiting side SW (15′W) by a single apparatus 15, it is possible to increase the reliability of channels (duplex them) by hardware satisfactory in reliability.

In the future, it is predicted that there will be an increase in systems using a transparent LAN service, a Layer 2 service, to outsource Layer 3 and higher functions to a data center and providing only Layer 2 hardware at the user side. According to the present invention, based on this prediction, it is possible to use only Layer 2 functions and reduce the effects (system changes etc.) on current hardware (repeating apparatuses) as much as possible.

Summarizing the effects of the invention, according to the present invention, by adding the least required expansion function to an inexpensive L2 switch in a current transparent LAN service, specifically by partially modifying or adding a program in the memory 32 of FIG. 4, it becomes possible to obtain a redundant configuration of the access channels. Due to this, it becomes possible to construct a duplex configuration network inexpensively even in a financially related system where reliability is paramount, so the invention can contribute remarkably to the growth of the network market in the future.

While the invention has been described with reference to specific embodiments chosen for purpose of illustration, it should be apparent that numerous modifications could be made thereto by those skilled in the art without departing from the basic concept and scope of the invention.

The present disclosure relates to subject matter contained in Japanese Patent Application No. 2002-9987, filed on Jan. 18, 2002, the disclosure of which is expressly incorporated herein by reference in its entirety.

What is claimed is

1. A duplexing method for duplexing an access channel for providing a transparent LAN service, which duplexing method comprises:
realizing a transparent LAN service by an active side network where only a plurality of active side repeating apparatuses can communicate with each other and a waiting side network where only a plurality of waiting side repeating apparatuses can communicate with each other and
switching the repeating apparatuses at the active side network and the repeating apparatuses at the waiting side network between these two by communication using specific frames mutually interpretable by only the repeating apparatuses.

2. A duplexing method as set forth in claim 1, wherein said transparent LAN service is an L2-VPN, while the above specific frames are specific Ethernet frames.

3. A repeating apparatus arranged between a transparent LAN service network and a local LAN for providing a transparent LAN service, provided with at least:
a switch processing means for switching general frames for data communication transferred between the transparent LAN service network and local LAN;
a survival confirmation frame transmitting means for transmitting a survival confirmation frame indicating that the repeating apparatus is surviving from that repeating apparatus to another opposing repeating apparatus by a predetermined period;
a frame receiving means for receiving opposing side survival confirmation frames similar to the above survival confirmation frame and the above general frames transmitted from the opposing repeating apparatus and transferring any general frames received to the switch processing means; and
a survival confirmation monitoring means for holding an opposing side survival confirmation frame corresponding to the opposing side repeating apparatus when the switch processing means receives such an opposing side survival confirmation frame, holding a flag indicating that the opposing repeating apparatus is surviving until the elapse of a predetermined holding period when receiving the next opposing side survival confirmation frame, while erasing that flag when that holding period elapses without the next opposing side survival confirmation frame being received;
when said flag has been erased by the survival confirmation monitoring means, the repeating apparatus operating as the active side being switched to the waiting side repeating apparatus and, simultaneously, the repeating apparatus operating as the waiting side being switched to the active side repeating apparatus.

4. A repeating apparatus as set forth in claim 3, further provided with a switch frame transmitting means for transmitting a switch frame by which the active side repeating apparatus instructs a waiting side repeating apparatus paired with it to switch to the active side when the above flag is erased by the survival confirmation monitoring means.

5. A repeating apparatus as set forth in claim 3, wherein the frame receiving means discards general frames when said frame receiving means receives general frames in the state where the active side repeating apparatus has been switched once to the waiting side.

6. A repeating apparatus as set forth in claim 3, further provided with a switchback frame transmitting means for transmitting a switchback frame by which the active side repeating apparatus instructs the waiting side repeating apparatus paired with that active side repeating apparatus to switch back to its inherent waiting side when the above flag is erased by the survival confirmation monitoring means in the state where the active side repeating apparatus has once been switched to the waiting side and having the active side repeating apparatus switched back to its inherent active side as well.

7. A repeating apparatus as set forth in claim 3, wherein the frame receiving means of the waiting side repeating apparatus discards any general frames received at all times.

8. A repeating apparatus as set forth in claim 6, wherein said waiting side repeating apparatus is switched back to its inherent waiting side when the frame receiving means receives said switchback frame from the active side repeating apparatus paired with that waiting side repeating apparatus without receiving the above survival confirmation frame in the state where the waiting side repeating apparatus has once been switched to the active side.

9. A repeating apparatus as set forth in claim 3, wherein the waiting side repeating apparatus generates an alarm for notifying the fact of an abnormality in the transparent LAN service when the above flag has been erased by the survival confirmation monitoring means.

10. A repeating apparatus in a transparent LAN service comprised of an active side repeating apparatus and waiting side repeating apparatus as set forth in any one of claims 3 to 9 provided independently and linked together.

11. A repeating apparatus in a transparent LAN service obtained by mounting an active side repeating function unit and waiting side repeating function unit to be mounted in an active side repeating apparatus and a waiting side repeating apparatus as set forth in any one of claims 3 to 9 and a single interface for commonly connecting these repeating function units and external networks in a single apparatus and selectively switching to one of the active side repeating function unit and waiting side repeating function unit by specific settings.

12. A repeating apparatus in a transparent LAN service, wherein providing an active side repeating function unit and waiting side repeating function unit to be mounted in an active side repeating apparatus and a waiting side repeating apparatus, respectively, and two interfaces for separately connecting these repeating function units and external networks in a single apparatus and simultaneously operating these repeating function units.

13. A transparent LAN service system comprised of:
an active side network by which only a plurality of active side repeating apparatuses can provide transparent LAN services to each other,
a waiting side network by which only a plurality of waiting side repeating apparatuses can provide transparent LAN services to each other, and
active/working side switch means for switching the active side repeating apparatuses and waiting side repeating apparatuses between the active and waiting sides by communication using specific frames mutually interpretable only among the repeating apparatuses and thereby duplexing access channels.

14. A repeating apparatus provided with:
a means for connecting a plurality of networks belonging to a first type to a network belonging to a second type and connecting these to two private networks constructed on the network belonging to the second type and
means for control to use one of the private networks among the two private networks as an active side and use the other private network as a waiting side.

15. A network connecting a plurality of networks belonging to a first type to a network belonging to a second type and constructing a private network on the network belonging to the second type, comprising:
an active side repeating apparatus for connecting each network belonging to the first type to a first private network constructed on the network belonging to the second type,
a waiting side repeating apparatus for connecting each network belonging to the first type to a second private network constructed on the network belonging to the second type, and
means for switching said waiting side repeating apparatus connected to the second private network to the active side when the active side repeating apparatus detects poor connection with the first private network.
